(19) United States
(12) Patent Application Publication
(10) Pub. No.: US 2013/0291761 A1
(43) Pub. Date: Nov. 7, 2013

(54) PORTABLE BITUMEN FOAMER APPARATUS

(71) Applicant: Andrew Tilman Cox, Blanco, TX (US)

(72) Inventor: Andrew Tilman Cox, Blanco, TX (US)

(21) Appl. No.: 13/675,290

(22) Filed: Nov. 13, 2012

Related U.S. Application Data
(60) Provisional application No. 61/559,242, filed on Nov. 14, 2011.

(51) Int. Cl. B01F 3/20; C08L 95/00

(52) U.S. Cl. CPC B01F 3/2078; C08L 95/00
USPC 106/122; 422/307

(57) ABSTRACT

A device for producing small-scale batches foamed bitumen. The device has a first pressurized, holding chamber for heating bitumen to a selected temperature, a second pressurized, holding chamber for heating bitumen additive (e.g., a foaming agent or chemical additive) to a selected temperature, and various conduits and valves as needed for delivering heated and pressurized bitumen with heated and pressurized additive to a mixing chamber having a selected volume to produce foamed bitumen.

### CROSS-REFERENCE TO RELATED APPLICATION

This application claims the benefit of U.S. Provisional Application No. 61/559,242 filed Nov. 14, 2011, the entire contents of which are incorporated herein by reference for all purposes.

### BACKGROUND

This invention is directed to a portable laboratory apparatus that generates a foamed bitumen using heated bitumen and a foaming agent.

Mixtures of bitumen and aggregate, commonly known as asphalt, are used in a wide variety of applications, particularly in the construction and maintenance of roads. The bitumen acts as a binder, coating individual aggregate particles and binding them together in the final composition.

Various technologies for preparing asphalt are known, including using foamed bitumen. Foamed bitumen is obtainable by injecting a foaming agent into heated bitumen. On contact with the hot bitumen, the foaming agent vaporizes, causing the bitumen to expand and foam. The foamed bitumen is then mixed with aggregate to form asphalt.

Unfortunately, not all types of bitumen and not all types of additives are suitable for use in foamed asphalt. Therefore, it would be advantageous if there were an easy method to test bitumen, additives, their various processing parameters, and the final asphalt product without requiring large scale road paving equipment.

### SUMMARY

The apparatus is a laboratory sized test unit that produces a controlled laboratory sized batch of foamed bitumen. The apparatus, for example, allows processing batches of bitumen from about 150 to 6,800 grams. The apparatus provides for readily changing or varying the ratio of bitumen to foaming agent or chemical additive in order to easily check, adjust and recheck a variety of bitumen/foaming agent formulations or alternative foam generating conditions with a minimal use of bitumen and foaming agent. A properly selected ratio of bitumen to foaming agent or chemical additive allows the foamed bitumen to be tailored to specific applications or end use conditions.

This disclosure describes a device for producing foamed bitumen. The device has a first pressurized, holding chamber for heating bitumen to a selected temperature, a second pressurized, holding chamber for heating bitumen additive (e.g., a foaming agent or chemical additive) to a selected temperature, and various conduits and valves as needed for delivering heated and pressurized bitumen with heated and pressurized additive to a mixing chamber having a selected volume to produce foamed bitumen. Either or both the first and second holding chambers may be heat-jacketed.

In some embodiments, the device is configured to heat the bitumen up to about 390° F., or up to about 410° F., such as within the range of about 370° F. to about 410° F. In some embodiments, the device is configured to heat the additive temperature may be up to about 180° F., or up to about 200° F., such as with the range of about 160° F. to about 200° F. In some embodiments, the device is configured to pressurize either or both the bitumen pressure and the additive up to about 70 psi, for example, about 12-17 psi.

The device can be configured so that the additive can be added to the mixing chamber before the bitumen is added to the mixing chamber. The device may include a foaming nozzle or valve that atomizes or produces an aerosol of the additive as it is delivered into the mixing chamber. Additionally or alternatively, the device may include a nozzle or valve that swirls or sprays the additive into to the mixing chamber. The additive may be introduced to the mixing chamber at a rate of about 0.75 to about 3.5 gallons per hour.

This disclosure also describes a first method for producing foamed bitumen. The method includes the steps of heating bitumen to a selected temperature in a first holding chamber, heating additive (e.g., a foaming agent or chemical additive) to a selected temperature in a second holding chamber, pressurizing the bitumen to a selected air pressure in said first holding chamber, pressurizing the additive to a selected air pressure in said second holding chamber, mixing the heated and pressurized bitumen with the heated and pressurized additive in a mixing chamber having a selected volume to form a foamed bitumen, and collecting the foamed bitumen in a container.

This disclosure also describes a second method for producing foamed bitumen. The method includes the steps of heating bitumen to a selected temperature in a first holding chamber, heating additive to a selected temperature in a second holding chamber, pressurizing the bitumen to a selected air pressure in said first holding chamber, pressurizing the additive to a selected air pressure in said second holding chamber, and mixing the heated and pressurized bitumen with the heated and pressurized additive in a mixing chamber to form a foamed bitumen, wherein the first holding chamber, second holding chamber, and mixing chamber are all contained within a portable device.

In any of the methods of this disclosure, the bitumen temperature may be up to about 390° F., or up to about 410° F., such as within the range of about 370° F. to about 410° F. In some embodiments, the additive temperature may be up to about 180° F., or up to about 200° F., such as with the range of about 160° F. to about 200° F. In some embodiments, either or both the bitumen pressure and the additive pressure may be up to about 70 psi, for example, about 12-17 psi. In some embodiments, changing the pressure of the additive changes the final mixture or composition of foamed bitumen. Additionally or alternately, changing the pressure of the bitumen may change the final mixture or composition of the foamed bitumen.

Additionally in any of the methods, the additive can be added to the mixing, chamber before the bitumen is added to the mixing chamber. The additive may be delivered to the mixing chamber by atomization or aerosolization. Additionally or alternatively, the additive may be delivered to the mixing chamber through a nozzle in a swirled spray pattern. The additive may be introduced to the mixing chamber at a rate of about 0.75 to about 3.5 gallons per hour.

These and various other features and advantages will be apparent from a reading of the following detailed description.

### BRIEF DESCRIPTION OF THE DRAWING

The disclosure may be more completely understood in consideration of the following detailed description of various embodiments of the disclosure in connection with the accompanying drawing, in which:

FIG. 1 is a schematic diagram of a portable bitumen foamer apparatus according to this disclosure.

Digital Image 2 shows a plan view of a portable bitumen foamer apparatus according to this disclosure, showing major components of the apparatus.

Digital Image 3 shows another plan view of the portable bitumen foamer apparatus of Digital Image 2, showing additional major components of the apparatus.

Digital Image 4 shows a control or operating panel for the present foamer apparatus according to this disclosure.

FIG. 5 is a perspective view of a portable bitumen foamer apparatus according to this disclosure.

### DETAILED DESCRIPTION

The present disclosure provides an apparatus and methods for producing batches (e.g., small or laboratory scale size batches) of foamed bitumen. The apparatus is a laboratory sized test unit that produces a controlled laboratory sized batch of foamed bitumen. The apparatus, for example, allows processing batches of bitumen from about 150 to 6,800 grams. The apparatus provides for readily changing or varying the ratio of bitumen to foaming agent or chemical additive in order to easily check, adjust and recheck a variety of bitumen/foaming agent formulations or alternative foam generating conditions with a minimal use of bitumen and foaming agent. A properly selected ratio of bitumen to foaming agent or chemical additive allows the foamed bitumen to be tailored to specific applications or end use conditions.

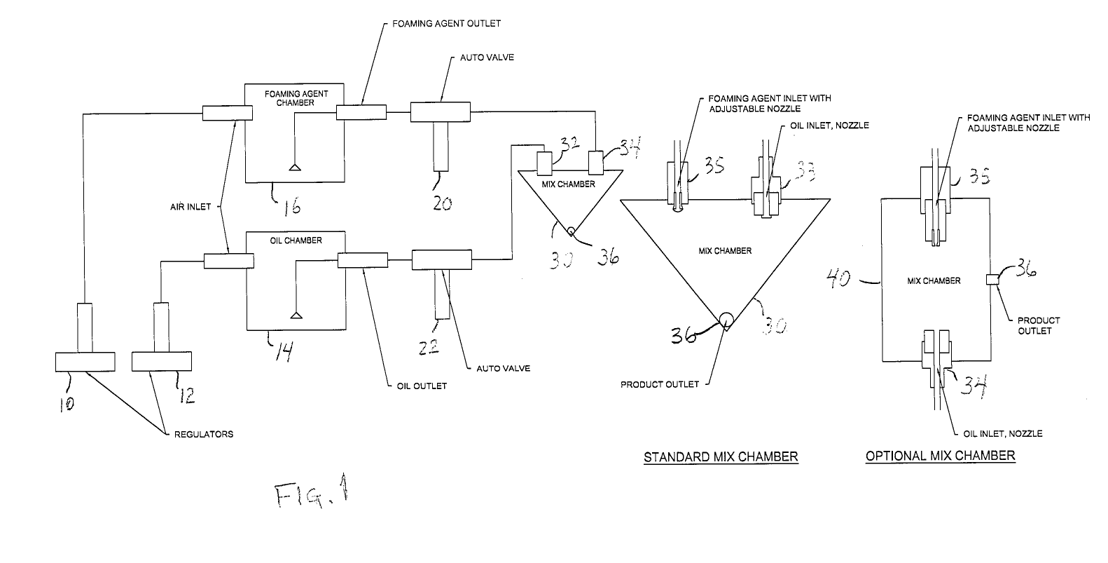

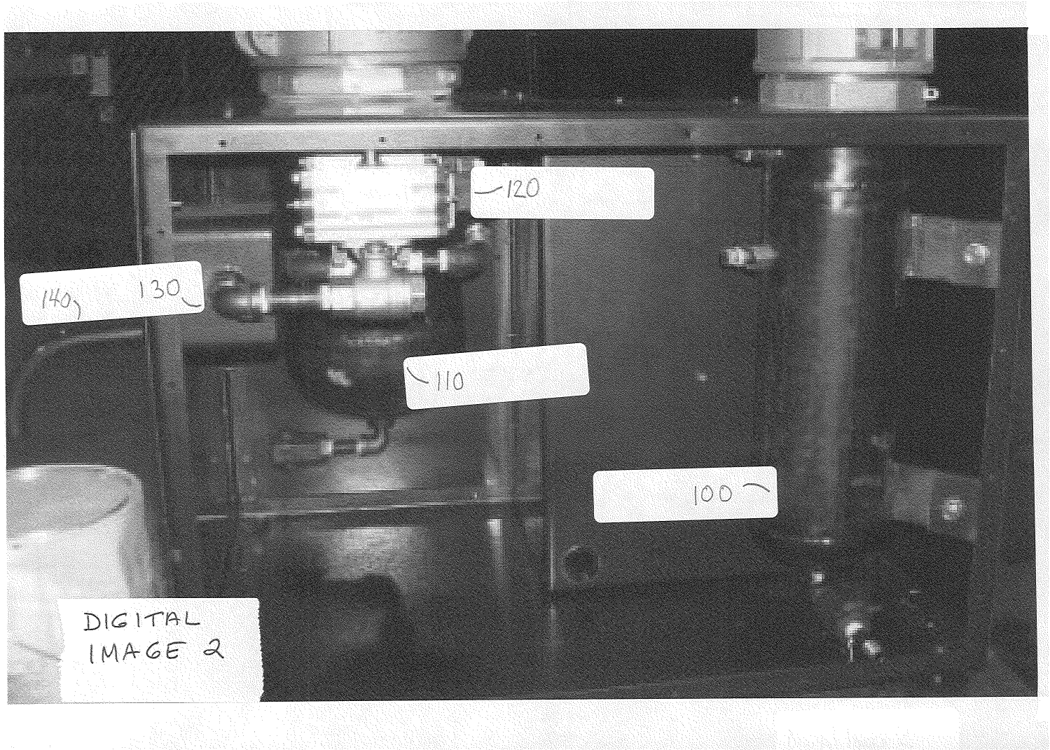

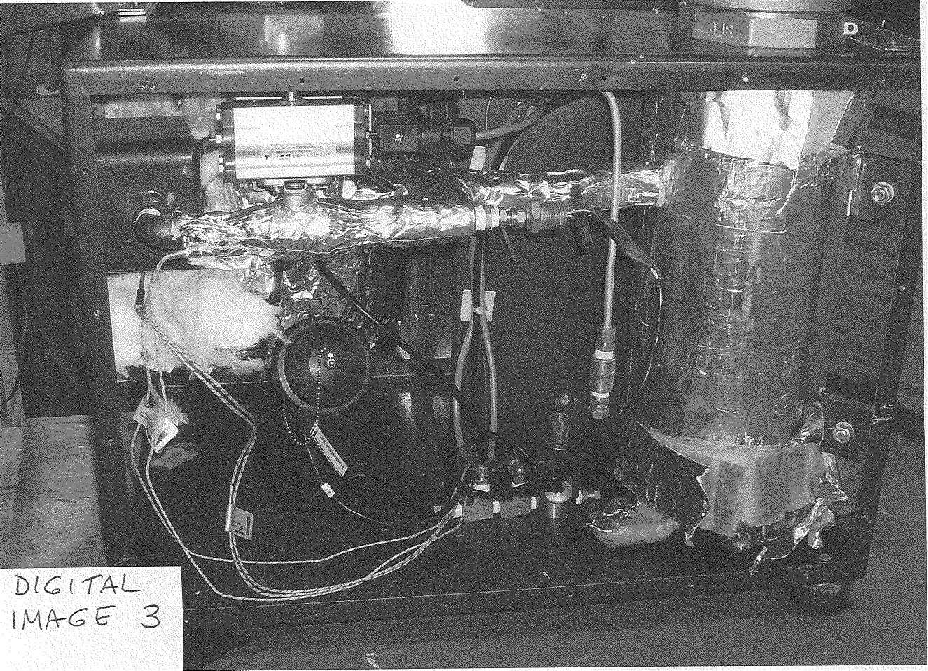

The major components of the portable laboratory apparatus are illustrated in FIG. 1. Compressed gas (e.g., air) from two separately controlled regulators 10 and 12 is used to pressurize both an oil or bitumen chamber 14 and a foaming agent chamber 16. The air pressure of each chamber is regulated separately and is used to control the individual flows of the bitumen and foaming agent into mixing chamber 30. The air pressure into both the foaming agent chamber and the bitumen chamber may vary in a range of approximately 12-70 psi. The present pneumatic system provides an apparatus that does not use or need any motors or pumps to move or transfer materials.

Both bitumen chamber 14 and foaming agent chamber 16 are heat jacketed using conventional electric heating elements and insulating materials. The bitumen chamber may be heated from ambient temperatures to about 390° F. The foaming agent chamber may be heated from ambient temperatures to about 180° F. In order to inhibit and preferably prevent loss of heat during the foaming generation process, the conduits or connecting lines from the foaming agent chamber and from the bitumen chamber to the mixing chamber are also heated with electric heating element and insulated (not shown), such as with conventional insulation materials.

Pressurized foaming agent flows through auto valve 20 into mix chamber 30. Similarly, pressurized bitumen flows through auto valve 22 into mixing chamber 30. The auto valves 20 and 22 are on-off valves that begin or end the foam generation process. In use, the foaming agent auto valve is opened slightly before or ahead of the bitumen auto valve in order to pre-charge the mixing chamber with foaming agent. The slight delay of bitumen flow into the mixing chamber provides a more desired initial foam generation process. Both the ratio and/or the flow rate of the bitumen and foaming agent are controlled by the amount of pressurization to the foaming agent and bitumen chambers together with the mix chamber inlet nozzles described below.

The mix or expansion chamber 30 includes a bitumen inlet and nozzle 32, a foaming agent and inlet nozzle 34, and a foamed product outlet 36. The mix chamber is also heat jacketed in order to regulate or control the temperature of the foaming generation process in the mix chamber.

In addition to mix or expansion chamber 30 described above, FIG. 1 also illustrates two alternate embodiments of a mix or expansion chamber. In the first alternate embodiment, mix chamber 30 has the foaming agent inlet and nozzle 35 fitted on the same wall of the chamber as the bitumen inlet and nozzle 33 in a side-by-side configuration. In the second alternate embodiment, mix chamber 40 has the foaming agent inlet and nozzle 35 fitted on one of the walls of the chamber opposite the wall fitted with the bitumen inlet and nozzle 33 in an opposed configuration. In any of the embodiments, the foaming nozzle 35 may be selected to provide a foaming agent at about 0.75 GPH (gallons per hour) to 3.5 GPH using about a 30 degree to 60 degree nozzle. In selected embodiments, the foaming nozzle 35 provides atomization or aerosolization of the foaming agent as it enters the mix chamber; atomization provides a desired foam generation process. In still other embodiments, the foaming nozzle 35 may be selected to provide a swirling spray pattern as foaming agents are charged to the mix chamber; swirling patterns may also provide desired foam generation.

In either mix chamber embodiments illustrated in FIG. 1, the oil or bitumen nozzle 33 may have an inlet opening in the range of about 0.065 inch to 0.125 inch. Together with the preselected air pressure to the bitumen chamber, the nozzle inlet opening may be used to control the flow rate and amount of bitumen that may be charged to the mix chamber.

After the foam is generated in the mix or expansion chamber 30, the pressure resulting from the foaming generating process forces the product out of the mix chamber via the product outlet 36 from which it may be collected in any suitable container. This allows the hottest and most volatile part of the process to be completed safely in the mix chamber and outlet pipe before the product reaches the external exposed container.

Digital Image 2 illustrates major components of the portable laboratory apparatus. In this image, a foaming agent chamber 100 and an oil or bitumen chamber 110 are identified. In addition, one of the two auto valves 120, a mix or expansion chamber 130, and a product outlet 140 are identified. In order to illustrate these components, no heating elements, connecting conduits or lines, or other electrical connections and controls are shown.

Digital Image 3 also illustrates the major components illustrated in Digital Image 2, however this image includes additional components including heating elements and insulation materials, connecting conduits or lines, and electrical connections and controls.

Digital Image 4 illustrates a control or operating panel for the present foamer apparatus. The various controls and indicators on the panel allow setting and/or changing the air pressure to each of the foaming agent chamber and bitumen chamber using the labeled bitumen and/or foaming agent regulators and pressure gauges in the center sections of the panel. The temperature of the bitumen and foaming agent chambers are separately controllable using the gauges at the bottom sections of the panel. Each chamber may also be individual calibrated using the calibration buttons identified on the top sections of the panel. The foaming generation is readily controlled using the foamer switch also identified on the top sections of the panel.

### EXAMPLE

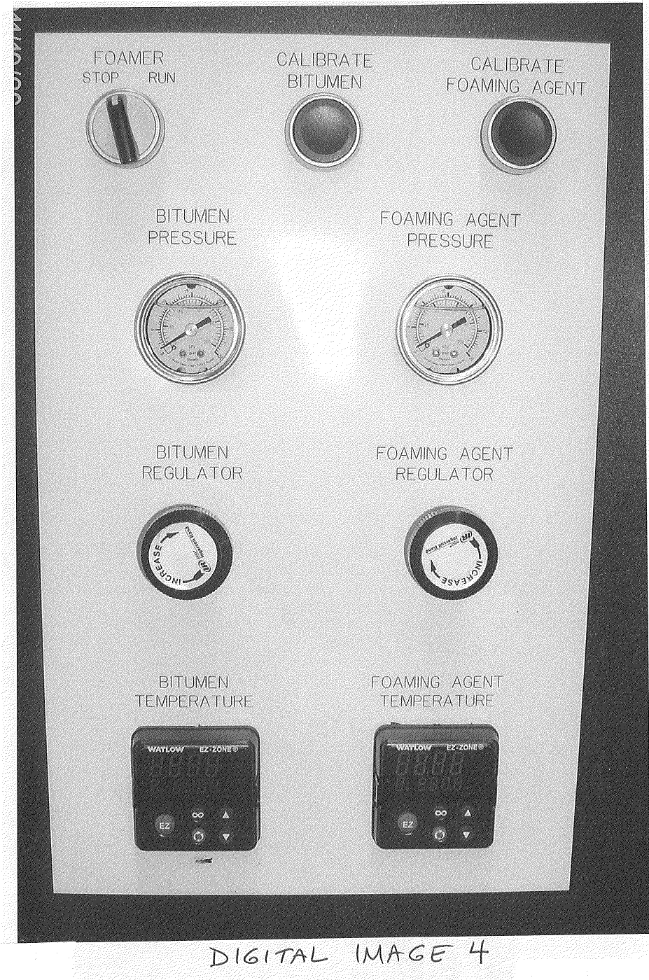

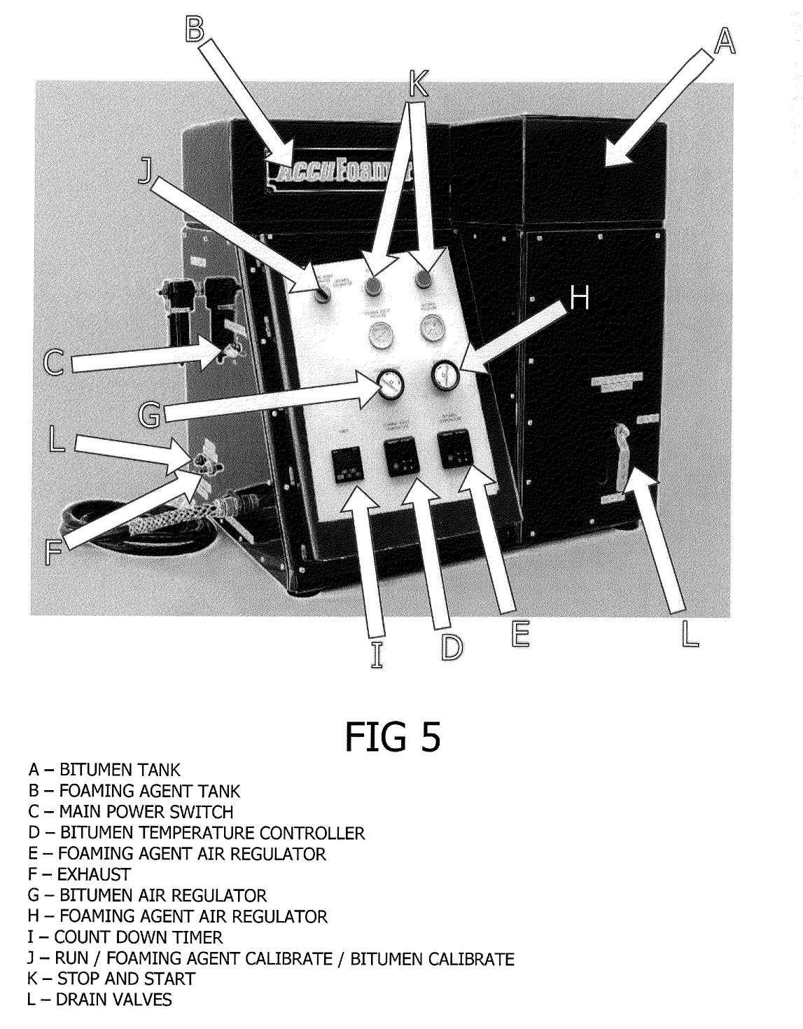

A foamed bitumen may be generated using a laboratory foamer apparatus illustrated in FIG. 5.

Operating procedures to obtain a foamed bitumen product include the following steps:

Check that both Drain Levers (L) are in the closed position.
1. Fill Bitumen Container (A) and Foaming Agent Container (B) with product, making sure safety lids are closed and latched and Safety Cover is shut.
2. Turn ON Power Switch (C).
3. Set Bitumen and Foaming Agent to desired temperature using respective Temperature Controllers (D) and (E).
4. Connect compressed air source to Inlet (F) (75 psi minimum-150 psi maximum)
5. Adjust Bitumen and Foaming Agent Air Regulators (G) and (H) to desired operating pressure (see the Bitumen and Foaming Calibration information below).
6. Bitumen pressure will be constant according to the size of the test container (for example, bitumen PSI=30 is used to calculate Chart 1 below).
7. Foaming agent pressure is set for desired percentage to be added (see Chart 1 below)
8. Switch (J) Foamer to RUN to begin filling test container.
9. Switch (J) Foamer to OFF when desired quantity of product has been produced.
10. Switches (K) open the Bitumen or Foaming Agent Valves as long as the button is depressed. May be used for calibration or evacuating container.
11. Levers (L) open drains for Bitumen and Foaming Agent containers.

CHART 1
Foaming Agent Set Point Percentages (Bitumen PSI = 30)

| Foaming Agent PSI | Foaming Agent Percentage |
|---|---|
| 0 | 0.00% |
| 10 | 5.77% |
| 15 | 12.50% |
| 20 | 15.38% |
| 25 | 21.15% |
| 30 | 26.92% |

If desired, both the bitumen and foaming agent may be calibrated by following the steps below.

Bitumen Calibration

The bitumen pressure will be a constant pressure. To determine this you will decide how fast you want to foam a batch. More pressure means faster batch foaming, but lower pressure (slower test) increases the accuracy of measurement.

Step 1: Preheat a full batch of bitumen in tank (A).

Step 2: Tare a 1-gallon can to determine the empty weight.
Set bitumen pressure to 10 psi.
Push and hold bitumen calibration button until 1-gallon can is close to full.
Time how many seconds are required to fill the can.
Weigh the bitumen material in ounces and record it.
If it is too slow, increase pressure to a higher psi and repeat step #2.

Step 3: After desired flow rate is determined, time and weigh the bitumen produced, record this on Chart B and then calibrate the foaming agent.

Foaming Agent Calibration

The foaming agent pressure will be set to achieve the desired percentage based on the flow rate of the bitumen. The results from this calibration test will populate Chart B to determine the correct psi setting for the foaming agent to achieve the desired percentage.

Step 1: Fill the foaming agent chamber (B).
Tare a new container.
Set foaming agent pressure to 5 psi.
Push and hold the foaming agent calibration button for the number of seconds you chose for your speed and recorded on Chart B. Weigh the foaming agent produced and record this amount.

Step 2: Repeat with the foaming agent pressure set to 25 psi and record the weight of the foaming agent produced at this pressure.

Step 3: Find the desired percentage of foaming agent to asphalt on Chart 1, above.
Set the foaming agent pressure to the corresponding psi to achieve the desired percentage.

Thus, embodiments of the PORTABLE BITUMEN FOAMER APPARATUS are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

1. A method of producing foamed bitumen, the method comprising the steps of:
heating bitumen to a selected temperature in a first holding chamber,
heating additive to a selected temperature in a second holding chamber,
pressurizing the bitumen to a selected air pressure in said first holding chamber,
pressurizing the additive to a selected air pressure in said second holding chamber,
mixing the heated and pressurized bitumen with the heated and pressurized additive in a mixing chamber having a selected volume to form a foamed bitumen, and
collecting the foamed bitumen in a container.

2. The method of claim 1, wherein heating additive comprises heating a foaming agent or chemical additive.

3. The method of claim 1 comprising heating bitumen to a temperature of about 370° F. to about 410° F.

4. The method of claim 1 comprising heating additive to a temperature of about 160° F. to about 200° F.

5. The method of claim 1 comprising pressurizing the bitumen to about 12-70 pounds per square inch.

6. The method of claim 1 comprising pressurizing the additive to about 12-70 pounds per square inch.

7. The method of claim 1, wherein the additive is added to the mixing chamber before the bitumen is added to the mixing chamber.

8. The method of claim 1, wherein changing the pressure of one or both of the bitumen and the additive changes the final mixture of foamed bitumen.

9. The method of claim 1, wherein the additive is introduced to the mixing chamber by atomization or aerosolization.

10. The method of claim 1, wherein the additive is introduced to the mixing chamber through a nozzle in a swirled spray pattern.

11. The method of claim 1, wherein the additive is introduced to the mixing chamber at a rate of about 0.75 to about 3.5 gallons per hour.

12. A method of producing foamed bitumen, the method comprising the steps of
heating bitumen to a selected temperature in a first holding chamber,
heating additive to a selected temperature in a second holding chamber,
pressurizing the bitumen to a selected air pressure in said first holding chamber,
pressurizing the additive to a selected air pressure in said second holding chamber,
mixing the heated and pressurized bitumen with the heated and pressurized additive in a mixing chamber to form a foamed bitumen,
wherein the first holding chamber, second holding chamber, and mixing chamber are all contained within a portable device.

13. The method of claim 12, comprising:
heating bitumen to a temperature of about 370° F. to about 410° F.; and
heating additive to a temperature of about 160° F. to about 200° F.

14. The method of claim 12, comprising:
pressuring the bitumen to about 12 to about 70 pounds per square inch; and
pressuring the additive to about 12 to about 70 pounds per square inch.

15. A device for producing foamed bitumen comprising:
a first pressurized, holding chamber for heating bitumen to a selected temperature,
a second pressurized, holding chamber for heating additive to a selected temperature, and
conduits and valves for delivering the heated and pressurized bitumen with the heated and pressurized additive to a mixing chamber having a selected volume to produce foamed bitumen.

16. The device of claim 15, wherein the first holding chamber is configured to heat the bitumen to a temperature of about 370° F. to about 410° F.

17. The device of claim 15, wherein the second holding chamber is configured to heat the additive to a temperature of about 160° F. to about 200° F.

18. The device of claim 15, wherein first holding chamber is configured to pressurize the bitumen to about 12-70 pounds per square inch.

19. The device of claim 15, wherein the second holding chamber is configured to pressure the additive to about 12-70 pounds per square inch.

20. The device of claim 15, wherein the first and second holding chambers are heat-jacketed.

21. The device of claim 15 comprising a nozzle operably connected to the second holding chamber to deliver additive to the mixing chamber by atomization or aerosolization.

22. The device of claim 15 comprising a nozzle operably connected to the second holding chamber to deliver additive to the mixing chamber in a swirled spray pattern.
